(19) United States
(12) Patent Application Publication
(10) Pub. No.: US 2023/0304339 A1
(43) Pub. Date: Sep. 28, 2023

(54) CONSOLE OPENING AND CLOSING DEVICE FOR VEHICLE

(71) Applicant: SHINKI INTER-MOBIL CO., LTD., Busan (KR)

(72) Inventors: Kyoung Sik KIM, Ansan-si (KR); Sang Jin JOUNG, Ulsan (KR); Hong Kil NOH, Asan-si (KR)

(21) Appl. No.: 17/851,400

(22) Filed: Jun. 28, 2022

(30) Foreign Application Priority Data
Mar. 23, 2022 (KR) 10-2022-0036061

(51) Int. Cl. E05D 11/06; B60R 7/04

(52) U.S. Cl. CPC E05D 11/06; B60R 7/04; E05Y 2201/224; E05Y 2900/53

(57) ABSTRACT

Disclosed herein is an armrest of a console for a vehicle. The console includes a storage box (S) having an open upper portion, a pair of side lids (20) supported on both sides of the upper portion of the storage box, and a center lid (10) rotatably supported by the side lids. An interference member (60) is mounted at the rear end of the center lid to regulate an opening angle of the center lid. The interference member includes a concave portion (62) formed concavely so that the rear end portion of the center lid can rotate in a certain section, and a concave front surface (62a) cause interference while the rear end portion of the center lid gets in contact with the concave front surface.

### CROSS-REFERENCE TO REPLATED APPLICATIONS

The present application is based upon and claims the benefit of priority to Korean Patent Application No. 10-2022-0036061 filed on Mar. 23, 2022, in the Korean Intellectual Property Office, which is incorporated herein by reference in its entirety.

### BACKGROUND OF THE INVENTION

### Field of the Invention

The present invention relates to a console opening and closing device for a vehicle, and more specifically, to a console opening and closing device for a vehicle which is configured to open and close an armrest bidirectionally to open and close a console and can regulate an opening angle of the armrest.

### Background Art

In general, a console is installed between a driver seat and a passenger seat of a vehicle. Such a console includes a storage box mounted at a lower part and an armrest for opening and closing the upper portion of the storage box. Moreover, the armrest includes side lids fixed to both sides of the storage box located at the lower part, and a center lid mounted between the side lids to be opened and closed.

Therefore, in substance, the center lid of the armrest opens and closes a storage room inside the storage box. Traditionally, because the armrest is mainly used by a driver, it is configured to be opened unidirectionally from the front to the rear. However, by various requests, Korean Utility Model Application No. 20-1994-0031556 (filed on Nov. 28, 1994) and Korean Patent Application No. 10-2004-0097620 (filed on Nov. 25, 2004) proposed armrest configured to be selectively opened from the front or the rear.

Besides the above, recently, products capable of being selectively opened and closed on both sides have been disclosed. However, such conventional arts are complicated in structure and it is difficult to implement realistically. In addition, in the case that the armrest is selectively opened or closed at the front or rear, there is no countermeasures for various disadvantages that could happen in the actual use.

### SUMMARY OF THE INVENTION

In the case of an armrest opening and closing a storage space while rotating around a hinge shaft, if an opening angle is too large, it is difficult to secure a structural strength. However, in the conventional arts, it is difficult to find mentions on regulation of the opening angle and the structural strength.

Therefore, it is an object of the present invention to provide an armrest opening and closing device which can maintain a structural strength and prevent a damage by unnecessary external force by limiting an opening angle of an armrest at a proper position.

It is another object of the present invention to provide an armrest opening and closing device which can firmly support the armrest.

To accomplish the above object, according to the present invention, there is provided a console opening and closing device for a vehicle including: a storage box having an open upper portion; a pair of side lids fixed and supported on both sides of the upper portion of the storage box; and a center lid rotatably supported by the side lids and opened and closed at one or more of the front and rear sides so as to open and close the open upper portion of the storage box. Moreover, an interference member is mounted at the rear end of the center lid corresponding to the upper portion of the rear end of the storage box to regulate an opening angle of the center lid. The interference member includes a concave portion formed concavely so that the rear end portion of the center lid can rotate in a certain section, and a concave front surface causing interference while the rear end portion of the center lid gets in contact with the concave front surface.

According to a preferred embodiment of the present invention, the interference member is supported by a metal frame supported on the storage box which is supported to surround the outer surface of the storage box.

According to the present invention, the rear end portion of the center lid gets in contact with the concave front surface of the interference member to cause interference so that the opening angle is regulated. Therefore, the present invention can sufficiently solve safety problems and secure structural strength by minimizing necessary components and regulating the opening angle of the console (center lid).

Additionally, according to the present invention, the interference member for regulating the opening angle of the console is supported by a frame made of a metal material, thereby sufficiently securing overall strength. Here, since the frame includes the lower frame surrounding the storage box, the present invention can reinforce the overall structural strength of the console.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating bidirectional opening and closing of an armrest according to the present invention;

FIG. 2 is a perspective view illustrating opening and closing of the armrest according to the present invention;

FIG. 3 is a perspective view showing essential parts for regulation of an opening angle of the armrest according to the present invention;

FIG. 4 is a perspective view showing essential parts for regulation of an opening angle of the armrest according to the present invention;

FIG. 5 is a sectional view illustrating regulation of an opening angle of the armrest according to the present invention;

FIG. 6 is a sectional view illustrating regulation of an opening angle of the armrest according to the present invention; and

FIG. 7 is a perspective view illustrating a configuration of a frame for the opening angle of the armrest according to the present invention.

### DETAILED DESCRIPTION OF THE PREFERRED EMBODIMENT

Hereinafter, the present invention will be described in more detail with reference to the embodiment illustrated in the drawings.

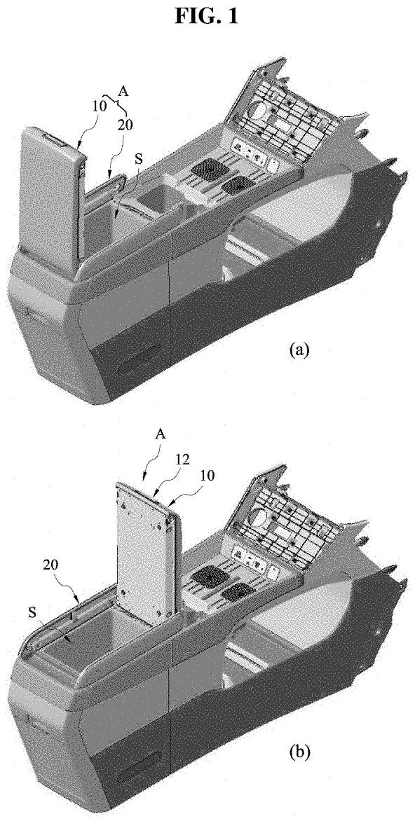

As illustrated in FIG. 1, a console installed between a driver seat and a passenger seat in a vehicle includes: a storage box S, such as a storage space, having an open upper portion; and an armrest A for opening and closing an open portion of the upper end of the storage box. The armrest A is installed on the top of the storage box S and is used to open and close the storage space of the storage box S.

The armrest A according to the present invention includes: a center lid 10 for opening and closing the storage box S; and a pair of side lids 20 fixed to both sides of the top of the storage box S to support the opening and closing of the center lid 10. FIG. 1(a) illustrates the center lid 10 opened backward, and FIG. 1(b) illustrates the center lid 10 opened forward.

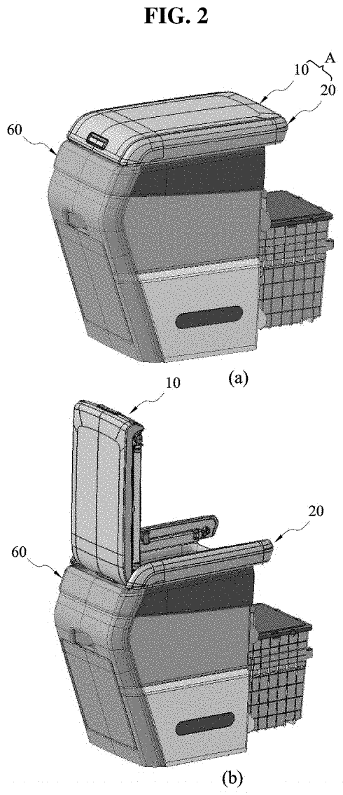

First, an embodiment for regulating an opening angle of the center lid 10 of the armrest A will be described. As illustrated in FIG. 2, in a closed state of the center lid 10 as illustrated in FIG. 2(a), when the center lid 10 is opened upward as illustrated in FIG. 2(b), the center lid 10 is designed to stop at a predetermined angle.

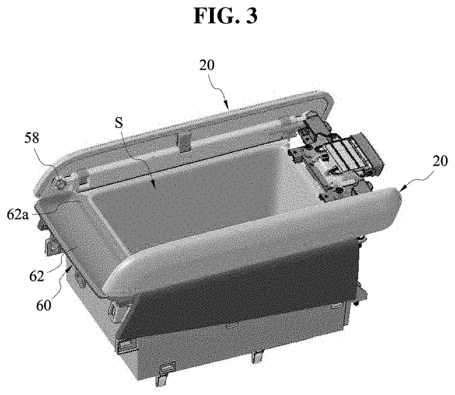

Here, regulating the opening angle of the center lid 10 at a predetermined angle is performed by an interference member 60 mounted at the rear of the center lid 10. That is, an interference occurs when the rear end portion of the center lid 10 collides with one side surface of the inside of the interference member 60. Hereinafter, referring to FIG. 3, such an internal configuration will be described.

As illustrated in FIGS. 2 and 3, based on the direction that the center lid 10 is opened, the interference member 60 is mounted on the upper portion of the storage box S corresponding to the rear end (rotating end) of the center lid. A concave portion 62 is formed on the upper surface of the interference member 60 in the same shape as the interference member in the transverse direction. Moreover, the center lid 10 opened and closed while being supported by the side lid 20 has a hinge hole 58 formed in the side lid 20 as an axis center.

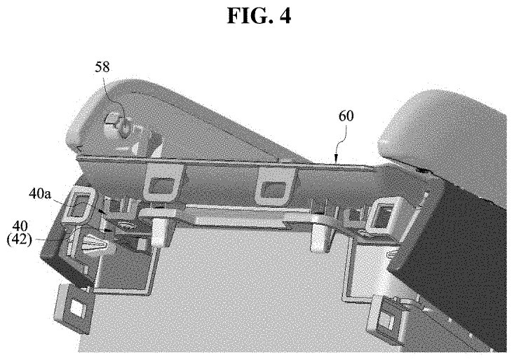

Of course, the interference member 60 can be supported by any part within a range that the interference member can be mounted at the above-described position. In the embodiment illustrated in FIG. 4, the interference member 60 is supported by a frame 40, and more particularly, is supported on a support part 40a of a lower frame 42 by bolts.

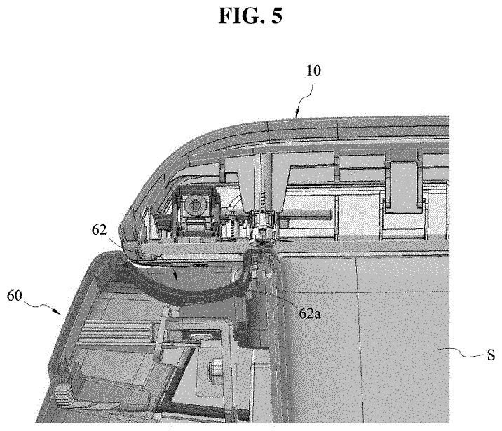

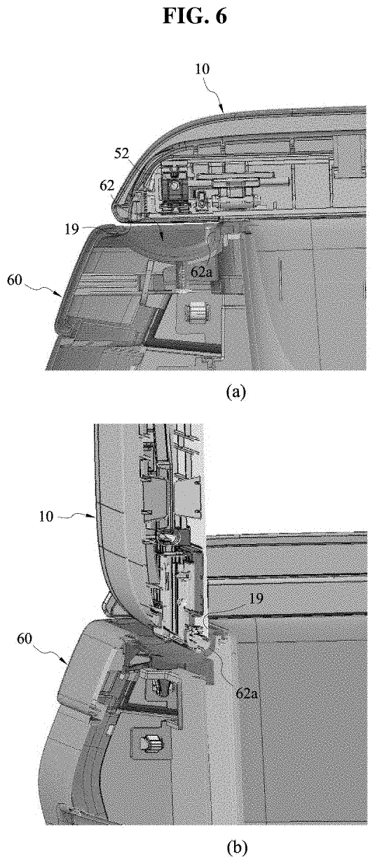

Furthermore, as illustrated in FIGS. 4 and 5, the rear end portion 19 of the center lid 10, which is opened while rotating around the hinge hole 58, is caught by a front surface 62a of the concave portion 62 of the interference member 60 as illustrated in FIG. 6. The rear end portion 19 of the center lid 10 causing interference with a concave front surface 62a of the interference member 60 is substantially the bottom surface (based on a closed state) of the rear end portion 19. As described above, the rear end portion 19 of the center lid 10 and the concave front surface 62a cause interference with each other after the rear end portion 19 is rotated at a predetermined angle while passing through the inside of the concave portion 62.

Therefore, for instance, when the center lid 10 is opened sufficiently to be almost vertical, the opening angle of the center lid 10 can be adjusted by designing the rear end portion 19 to get in contact with the front surface 62a. Here, the opening angle of the center lid 10 can be sufficiently adjusted by properly designing the shape of the concave portion 62 and the forming position of the front surface 62a.

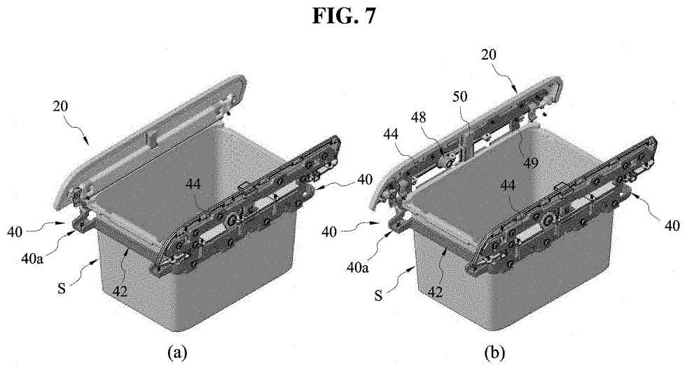

Next, referring to FIG. 7, the frame 40 which substantially supports the interference member 60 will be described. The frame 40 for reinforcing a structural strength for opening and closing the upper portion of the storage box S includes a lower frame 42 and upper frames 44. The lower frame 42 has a rectangular shape surrounding the side surface of the storage box S, and the upper frames 44 are formed to face each other to support a pair of the side lids 20.

The lower frame 42 and the upper frames 44 are connected by a connection part 49. Additionally, as illustrated in FIGS. 4 and 7, the interference member 60 according to the present invention is connected to a supporting part 40a formed on one side of the lower frame 42 by a bolt. However, such a structure for supporting the interference member 60 is not limited thereto, and the interference member can be supported by other peripheral components which form the console.

Since the frame 40 is to secure the structural strength, it is preferable that the frame 40 may be formed of a metal material. For example, the frame 40 may be made of aluminum diecasting. In addition, the frame 40 may further include other components besides those described in the present specification.

As described above, the present invention is characterized in that the center lid opening and closing angle of the armrest can be regulated by using the interference relation between the rear end portion of the center lid opened and closed and the interference member. It is obvious to a person skilled in the art that various modifications and changes can be made within the scope of the basic technical idea of the present invention. In addition, it should be appreciated that the protective scope of the present invention is interpreted based on the claims set forth.

What is claimed is:

1. A console opening and closing device for a vehicle comprising:
a storage box having an open upper portion;
a pair of side lids fixed and supported on both sides of the upper portion of the storage box;
a center lid rotatably supported by the side lids and opened and closed forward or backward so as to open and close the open upper portion of the storage box; and
an interference member mounted at the rear end of the center lid corresponding to the upper portion of the rear end of the storage box to regulate an opening angle of the center lid,
wherein the interference member includes a concave portion formed concavely so that the rear end portion of the center lid can rotate in a certain section, and a concave front surface causing interference while the rear end portion of the center lid gets in contact with the concave front surface.

2. The console opening and closing device according to claim 1, wherein the interference member is supported by a metal frame supported on the storage box.

3. The console opening and closing device according to claim 2, wherein the frame comprises: a lower frame supported on the storage box while surrounding the side surface of the storage box; and a pair of upper frames extending upward from the lower frame to support the side lids,
wherein the interference member is supported on the lower frame.
